(19) United States
(12) Patent Application Publication
(10) Pub. No.: US 2021/0174770 A1
(43) Pub. Date: Jun. 10, 2021

(54) DISPLAYS OF POINT OF SALE DEVICES

(71) Applicants: Zhang-Bin LIN, Shanghai (CN); Jie-Ming JIANG, Shanghai (CN); Chang-Fa XU, Shanghai (CN); Hewlett-Packard Development Company, L.P., Spring, TX (US)

(72) Inventors: Zhang-Bin Lin, Shanghai (CN); Jie-Ming Jiang, Shanghai (CN); Chang-Fa Xu, Shanghai (CN)

(73) Assignee: Hewlett-Packard Development Company, L.P., Spring, TX (US)

(21) Appl. No.: 17/043,826

(22) PCT Filed: Aug. 30, 2018
(86) PCT No.: PCT/CN2018/103194

§ 371 Date: Sep. 30, 2020

(51) Int. Cl. G09G 5/38; G06F 3/14; G02B 27/01

(52) U.S. Cl. CPC G09G 5/38; G06F 3/14; G06Q 20/209; G09G 2354/00; G02B 2027/0154; G02B 27/0149

(57) ABSTRACT

A point of sale (POS) device (400) includes a primary display (102) to illustrate content in a first direction, and a secondary display (104) to reflect a first content illustrated from a first section of the primary display (102), wherein the first content is reflected in a second direction opposite to the first direction.

### BACKGROUND

Point of sale (POS) devices provide the ability for businesses to interact with their customers. As an example, in retail environments, an associate may be located on one side of a POS device, and customers may be located on another side of the POS device, for example, opposite from the associate. In addition to a display panel being available for an associate to conduct a transaction with a customer on the POS device, a display panel may be required for the customer as well, for example, to view information about the items being purchased during the transaction, such as the quantity & price of each item.

### BRIEF DESCRIPTION OF THE DRAWINGS

FIGS. 1A-B illustrate a POS device with a secondary display to reflect information from a primary display, according to an example;

FIG. 2 illustrates a side profile of the POS device, according to an example;

FIGS. 3A-B illustrate sample content displayed on the primary display, and content illustrated from a section of the primary display that may also be reflected by the secondary display, according to an example; and

FIG. 4 illustrates a POS device with the primary display and secondary display, according to an example.

### DETAILED DESCRIPTION

Examples disclosed herein provide the ability for a secondary display of a POS device to reflect information projected from a primary display of the POS device. As an example, the secondary display may correspond to a heads-up display (HUD) directed towards customers, which reflects a virtual image of the information projected from the primary display facing the associate. As will be further described, the information reflected from the primary display onto the HUD may be information relevant for customers to complete a transaction. Rather than having to introduce mechanisms to switch the primary display between the associate and customer, or including an additional electronic display for the customer, which may both be cost-prohibitive, a transparent display provided by the HUD may simply reflect a virtual image of the relevant information to the customer from the primary display.

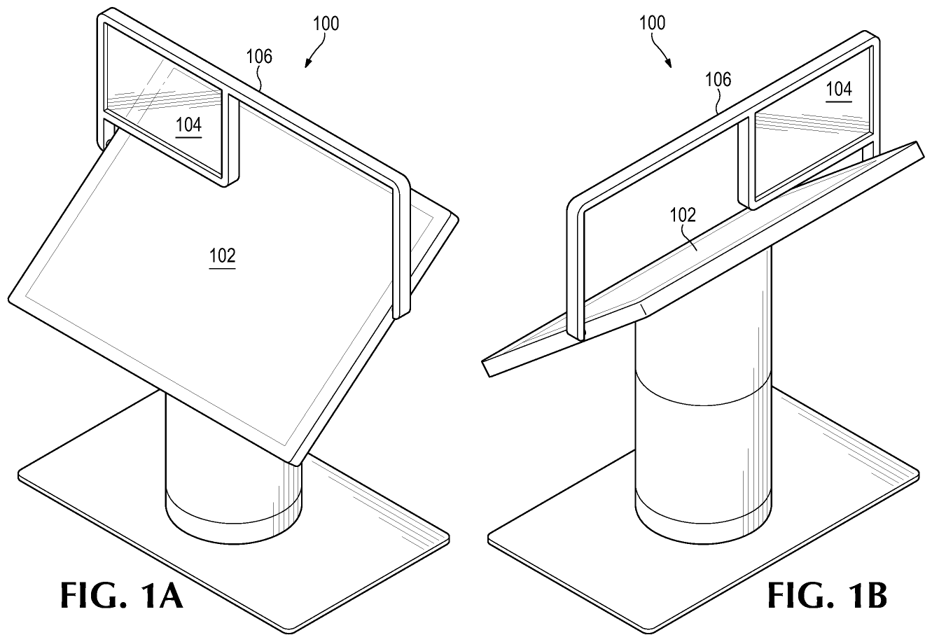

With reference to the figures, FIGS. 1A-B illustrate a POS device 100 with a secondary display 104 to reflect information from a primary display 102, according to an example. The primary display 102 illustrates content in a first direction, illustrated in FIG. 1A, for example, facing a merchant or associate. As will be further described, the secondary display 104 reflects a virtual image of the content illustrated from the primary display 102, in a second direction opposite the first direction, illustrated in FIG. 1B, for example, facing customers.

As an example, the secondary display 104 is a HUD including a transparent display to reflect content illustrated from the primary display 102. The transparent display may be a transparent glass panel or transparent acrylic panel, with a reflective film or coating to appropriately reflect content illustrated from the primary display 102. The secondary display 104 may be coupled to a frame 106 that may be adjustable, in order to angle the secondary display 104 with respect to the primary display 102, for example, in order for customers to clearly view the information reflected from the secondary display 104. As an example, the secondary display 104 may be adjusted to be oblique with respect to the primary display 102. However, the angle of the frame 106 with respect to the primary display 102 may be fixed at an angle that is appropriate for viewing. Placement of the secondary display 104 may vary as well. For example, the secondary display 104 may be on either end of the frame 106, in order to reflect content on either the upper left or upper right section of the primary display 102.

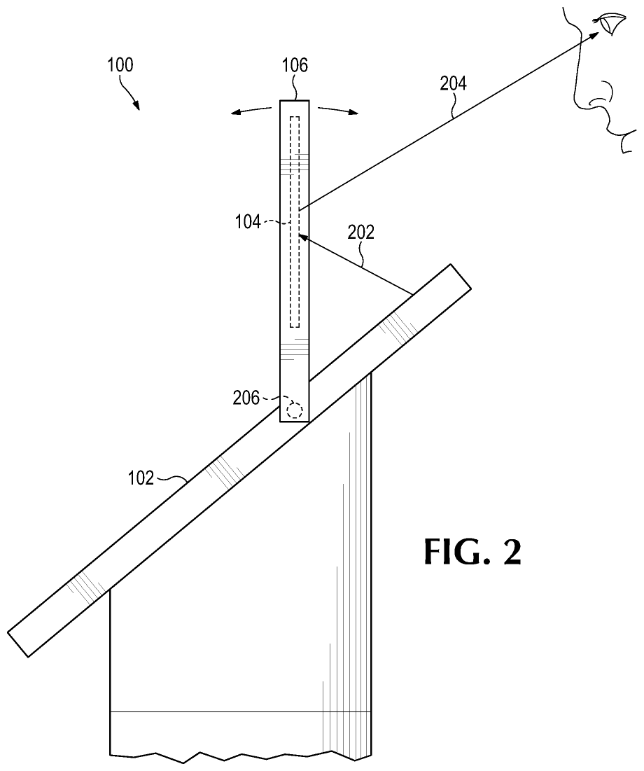

FIG. 2 illustrates a side profile of the POS device 100, according to an example. As illustrated by the arrows on either side of the frame 106, the frame 106 may be adjustable, for example, at pivot point 206, in order to angle the secondary display 104 with respect to the primary display 102. For example, the secondary display 104 may be adjusted to be oblique with respect to the primary display 102 (e.g., 45 degrees plus or minus 15 degrees). As will be further described, content illustrated from the primary display 102 in a first direction 202 may be reflected by the secondary display 104 in a second direction 204 opposite to the first direction 202, to be viewable by customers, as illustrated. Tilt adjustments made to the frame 106 may adjust the viewing angle. As will be further described, as the adjustments are made to the frame 106 in order to angle the secondary display 104 with respect to the primary display 102, corresponding adjustments may be made to the placement of the content illustrated by the primary display 102, according to the amount the frame 106 is adjusted.

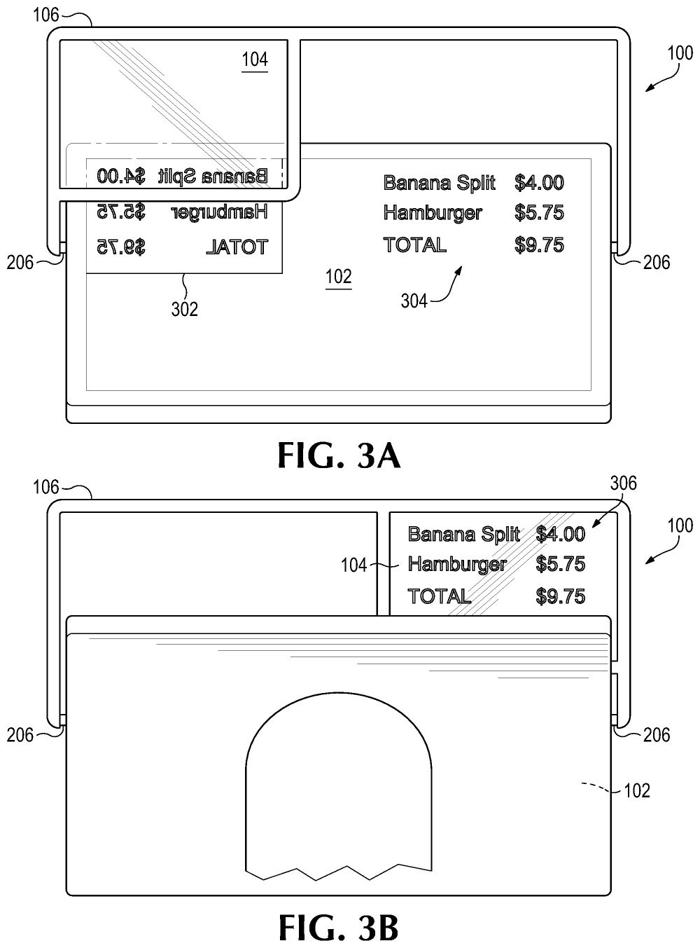

FIGS. 3A-B illustrate sample content displayed on the primary display 102, and content illustrated from a section 302 of the primary display 102 that may also be reflected by the secondary display 104, according to an example. As an example, in order for the content illustrated from section 302 of the primary display 102 to be reflected properly, as illustrated on secondary display 104 in FIG. 3B, the content illustrated from section 302 may be horizontally flipped, or flipped around a vertical axis, as illustrated in FIG. 3A. Otherwise, the virtual image reflected by the secondary display 104 may be backwards. Referring to FIG. 3A, as section 302 includes the content horizontally flipped for the secondary display 104 to reflect, another section 304 of the primary display 102, different from the first section 302, may include the same content as the content illustrated in the first section 302, but in the correct orientation for an associate facing the primary display 102 to read. As a result, the first content from the first section 302 may correspond to the second content from the second section 304, but in a horizontally flipped manner, wherein the first content is the second content flipped around a vertical axis. As an example, a controller associated with the POS device 100 illustrates content between the first and second sections 302, 304, and any other sections, in addition to horizontally flipping any content.

As previously mentioned, as the frame 106 containing the secondary display 104 may be adjusted, for example, from a first position to a second position, placement of the first content in the first section 302 may be adjusted accordingly, for example, according to the amount the frame 106 is adjusted. The controller associated with the POS device 100 may make determinations with regards to adjustments to be made to the placement of the first content in the first section 302 of the primary display 102. As a result, the virtual image reflected by the secondary display 104 may include the relevant information viewable for customers facing the secondary display 104.

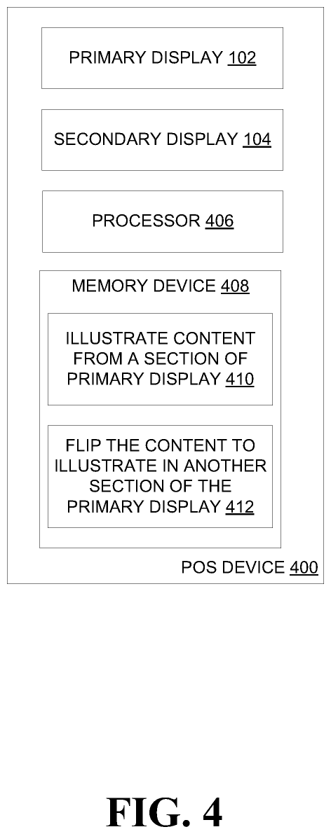

FIG. 4 illustrates a POS device 400 with the primary display 102 and secondary display 104, according to an example. As described above, the primary display 102 illustrates content in a first direction, for example, facing a merchant or associate, and the secondary display 104 reflects content illustrated from the primary display 102, in a second direction opposite the first direction, for example, facing customers. The secondary display 104 may be coupled to a frame that may be adjustable, in order to angle the secondary display 104 with respect to the primary display 102, for example, in order for customers to clearly view the information reflected from the secondary display 104.

The POS device 400 depicts a processor 406 and a memory device 408 and, as an example of the POS system 400 performing its operations, the memory device 408 may include instructions 410-412 that are executable by the processor 406. Thus, memory device 408 can be said to store program instructions that, when executed by processor 406, implement the components of the POS device 400. The executable program instructions stored in the memory device 408 include, as an example, instructions to illustrate content from a section of primary display 102 (410), and instructions to flip the content to illustrate in another section of the primary display 102 (412).

Instructions to illustrate content from a section of primary display 102 (410) represent program instructions that when executed by the processor 406 cause the POS device 400 to illustrate content from a section of the primary display 102, for example, viewable for an associate facing the primary display 102. Referring back to FIG. 3A, content from the second section 304 of the primary display 102 may correspond to the section viewable for the associate.

Instructions to flip the content to illustrate in another section of the primary display 102 (412) represent program instructions that when executed by the processor 406 cause the POS device 400 to flip the content around a vertical axis. Referring back to FIG. 3A, content from the first section 302 of the primary display 102 may correspond to the other section containing the horizontally flipped content. As a result, content from section 304 is viewable from the primary display 102 for the associate, and the horizontally flipped content from section 302 is reflected by the secondary display 104 to be viewable by customers opposite the associate.

Memory device 408 represents generally any number of memory components capable of storing instructions that can be executed by processor 406. Memory device 408 is non-transitory in the sense that it does not encompass a transitory signal but instead is made up of at least one memory component configured to store the relevant instructions. As a result, the memory device 408 may be a non-transitory computer-readable storage medium. Memory device 408 may be implemented in a single device or distributed across devices. Likewise, processor 406 represents any number of processors capable of executing instructions stored by memory device 408. Processor 406 may be integrated in a single device or distributed across devices. Further, memory device 408 may be fully or partially integrated in the same device as processor 406, or it may be separate but accessible to that device and processor 406.

In one example, the program instructions 410-412 can be part of an installation package that when installed can be executed by processor 406 to implement the components of the POS device 400. In this case, memory device 408 may be a portable medium such as a CD, DVD, or flash drive or a memory maintained by a server from which the installation package can be downloaded and installed. In another example, the program instructions may be part of an application or applications already installed. Here, memory device 408 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A point of sale (POS) device comprising:
a primary display to illustrate content in a first direction; and
a secondary display to reflect a first content illustrated from a first section of the primary display, wherein the first content is reflected in a second direction opposite to the first direction.

2. The POS device of claim 1, wherein the primary display is to illustrate a second content from a second section of the primary display different from the first section.

3. The POS device of claim 2, wherein the first content corresponds to the second content, but in a horizontally flipped manner, wherein the first content is the second content flipped around a vertical axis.

4. The POS device of claim 1, comprising:
an adjustable frame to angle the secondary display with respect to the primary display.

5. The POS device of claim 4, wherein the secondary display is oblique with respect to the primary display.

6. The POS device of claim 1, wherein the secondary display is a heads-up display (HUD) comprising a transparent display to reflect the first content illustrated from the first section of the primary display.

7. A point of sale (POS) device comprising:
a primary display to illustrate content in a first direction;
a secondary display to reflect a first content illustrated from a first section of the primary display, wherein the first content is reflected in a second direction opposite to the first direction; and
a controller to:
illustrate a second content from a second section of the primary display; and
flip the second content around a vertical axis to illustrate the first content from the first section of the primary display, wherein the first content corresponds to the second content, but in a horizontally flipped manner.

8. The POS device of claim 7, comprising:
an adjustable frame to angle the secondary display with respect to the primary display.

9. The POS device of claim 8, wherein while the frame is adjusted from a first position to a second position, the controller is to adjust placement of the first content on the primary display according to the amount the frame is adjusted.

10. The POS device of claim 8, wherein the secondary display is oblique with respect to the primary display.

11. The POS device of claim 7, wherein the secondary display is a heads-up display (HUD) comprising a transparent display to reflect the first content illustrated from the first section of the primary display.

12. A non-transitory computer-readable storage medium comprising program instructions which, when executed by a processor, cause the processor to:
illustrate a first content from a first section of a primary display of a point of sale (POS) device in a first direction, wherein the first content is to be reflected on a secondary display in a second direction opposite to the first direction; and
illustrate a second content from a second section of the primary display, wherein the first content corresponds to the second content, but in a horizontally flipped manner, wherein the first content is the second content flipped around a vertical axis.

13. The non-transitory computer-readable storage medium of claim 12, wherein as an adjustable frame is to angle the secondary display with respect to the primary display, comprising instructions to cause the processor to adjust placement of the first content on the primary display according to the amount the frame is adjusted.
